(19) United States
(12) Patent Application Publication
(10) Pub. No.: US 2015/0371134 A1
(43) Pub. Date: Dec. 24, 2015

(54) PREDICTING CIRCUIT RELIABILITY AND YIELD USING NEURAL NETWORKS

(71) Applicant: SEMICONDUCTOR MANUFACTURING INTERNATIONAL (SHANGHAI) CORPORATION, Shanghai (CN)

(72) Inventors: WEITING CHIEN, Shanghai (CN); HOWKING SII, Shanghai (CN); SHENG KANG, Shanghai (CN)

(21) Appl. No.: 14/736,231

(22) Filed: Jun. 10, 2015

(30) Foreign Application Priority Data
Jun. 19, 2014 (CN) 201410276855.7

(51) Int. Cl. G06N 3/08

(52) U.S. Cl. CPC G06N 3/08

(57) ABSTRACT

A system and method for predicting a product characteristic are provided. The system includes a data acquisition module configured to acquire raw data associated with to-be predicted prediction information, a data conversion module configured to convert the raw data into computable normalized data, and a result prediction module configured to calculate a prediction result based on the normalized data and compare the prediction result with a predetermined standard value. The result prediction module includes a neural network prediction model configured to calculate the prediction result based on the normalized data. The prediction information may include reliability and/or yield to prevent major reliability or yield problems from occurring during manufacturing of semiconductor devices.

### CROSS-REFERENCES TO RELATED APPLICATIONS

This application claims priority to Chinese patent application No. 201410276855.7, entitled “PREDICTING CIRCUIT RELIABILITY AND YIELD USING NEURAL NETWORKS” filed Jun. 19, 2014, the content of which is incorporated herein by reference in its entirety.

### BACKGROUND OF THE INVENTION

The present invention relates generally to semiconductor device manufacturing, and more particularly to a system and method for predicting reliability and yield of a semiconductor device.

Yield and reliability are two important factors that may affect the development and profitability of semiconductor device manufacturing. Traditionally, semiconductor device reliability has been estimated from accelerated stress tests after the completion of manufactured semiconductor devices. Similarly, yield may be obtained from wafer test results after the completion of the manufactured semiconductor device. Because wafer yield and reliability risk are critical parameters for profitability, accurate prediction of yield and reliability is essential to ensure profitability.

Currently, the assessment of reliability risk and yield can only be obtained through testing of fully processed wafers or based on previously gained experience. End-of-line testing may be too late to take corrective action to correct defects. This results in potentially high risk because the fully processed wafers may have to be scrapped, causing increased costs of manufactured semiconductor devices.

The prior art does not provide an inline prediction capability to solve the problems related to reliability and yield of semiconductor devices. Therefore, there is a needed for systems and methods for inline predicting reliability risk and yield performance of semiconductor devices.

### BRIEF SUMMARY OF THE INVENTION

Embodiments of the present invention provide a predictive system and method for predicting reliability risk and yield performance of manufactured semiconductor devices that can prevent reliability and yield problems from occurring during a manufacturing process of semiconductor devices according to inline real-time data acquisition.

In one embodiment, a system for product reliability and/or yield prediction may include a data acquisition module configured to acquire raw data associated with to-be predicted prediction information, a data conversion module configured to convert the raw data into computable normalized data, and a result prediction module configured to calculate a prediction result based on the normalized data and compare the prediction result with a predetermined standard value. The result prediction module includes a neural network prediction model configured to calculate the prediction result based on the normalized data. The to-be predicted prediction information may include reliability and/or yield of semiconductor devices in a manufacturing process.

In one embodiment, the neural network prediction model may include one or more parameters that can be determined by an experimental range, an experimental design table, and a minimum average error value.

In one embodiment, the result prediction module further includes a prediction result judgment unit coupled to the neural network prediction model and configured to compare the prediction result with the predetermined standard value to obtain a comparison result, and make a judgment in response to the comparison result.

In one embodiment, the predetermined standard value includes a valid standard value and an invalid standard value, and the prediction result judgment unit is operable to make: a normal operation judgment when the prediction result is above the valid standard value, an abnormal operation judgment when the prediction result is below the invalid standard value, and an analysis judgment when the prediction result is between the invalid standard value and the valid standard value.

In one embodiment, the data acquisition module sends the acquired raw data to a database for storage. The raw data may include inline measurement data, machine monitoring system data, processing time and idle time data, and wafer electrical test data. In one embodiment, the machine monitoring system data includes power, pressure, thermal head temperature, gas, and the inline measurement data includes a width of metal wirings, a width of trenches, a thickness of an insulating layer, a diameter of a through hole.

In one embodiment, the data conversion module may include a data format conversion unit and a data normalization unit configured to perform the following expression:

(Value−Min)/(Max−Min)

where Value is an actual data value, and Max is a maximum data value and Min is a minimum value used for modeling the neural network prediction model.

In one embodiment, the system further includes a model parameter test module configured to compare an actual test result with the prediction result, compare a false positive rate with a default value, cause the system to output model optimization instructions in the event that the actual test result exceeds the prediction result and the false positive rate exceeds the default value, and cause the system to operate normally in the event that the actual test result does not exceed the prediction result and the false positive rate does not exceed the default value.

Embodiments of the present invention also provide a method for predicting product reliability and/or yield. The method includes: acquiring raw data associated with to-be predicted prediction information, which includes the product reliability and/or yield; converting the raw data into computable normalized data; calculating a prediction result based on the normalized data using a neural network prediction model; and comparing the prediction result with a predetermined standard value.

In one embodiment, the neural network prediction model includes at least one parameter determined by the following steps: setting an experimental range; conducting experiments using an experimental design table to obtain one or more experimental results; judging an average error value in response to the one or more experimental results; and determining a minimum error value as the at least one parameter for the neural network prediction model.

In one embodiment, comparing the prediction result with the predetermined standard value may include: in the event that the prediction result is above a valid standard value, determining that the to-be predicted prediction information is normal; in the event that the prediction result is below an invalid standard value, determining that the to-be predicted prediction information is abnormal; and in the event that the prediction result is between the valid standard value and the invalid standard value, determining that the to-be predicted prediction information is required to be submitted to an analysis.

In one embodiment, the method also includes: comparing an actual test result with the prediction result; comparing a false positive rate with a default value; in the event that the actual test result exceeds the prediction result and the false positive rate exceeds the default value, outputting instructions for model optimization; in the event that the actual test result does not exceed the prediction result and the false positive rate does not exceed the default value, operating the semiconductor device manufacturing process normally.

The following description, together with the accompanying drawings, will provide a better understanding of the nature and advantages of the claimed invention.

### BRIEF DESCRIPTION OF THE DRAWINGS

FIG. 1 is a simplified block diagram of an exemplary system for predicting reliability and/or yield of a semiconductor device during a manufacturing process according to one embodiment of the present invention;

FIG. 2 is a simplified flow chart of a method for predicting reliability and/or yield of a semiconductor device during a manufacturing process according to one embodiment of the present invention;

FIG. 3 is a simplified flow chart of a method for predicting reliability and/or yield of a semiconductor device during a manufacturing process according to another embodiment of the present invention.

### DETAILED DESCRIPTION OF THE INVENTION

In the following description, numerous specific details are provided for a thorough understanding of the present invention. However, it should be appreciated by those of skill in the art that the present invention may be realized without one or more of these details. In other examples, features and techniques known in the art will not be described for purposes of brevity.

It should be understood that the drawings are not drawn to scale, and similar reference numbers are used for representing similar elements. As used herein, the terms “example embodiment,” “exemplary embodiment,” and “present embodiment” do not necessarily refer to a single embodiment, although it may, and various example embodiments may be readily combined and interchanged, without departing from the scope or spirit of the present invention. Furthermore, the terminology as used herein is for the purpose of describing example embodiments only and is not intended to be a limitation of the invention. In this respect, as used herein, the terms “a”, “an” and “the” may include singular and plural references. Furthermore, as used herein, the term “by” may also mean “from”, depending on the context. Furthermore, as used herein, the term “if” may also mean “when” or “upon”, depending on the context. Furthermore, as used herein, the words “and/or” may refer to and encompass any possible combinations of one or more of the associated listed items.

It will be further understood that the terms “comprising”, “including having” and variants thereof, when used in this specification, specify the presence of stated features, steps, operations, elements, and/or components, but do not preclude the presence or addition of one or more other features, steps, operations, elements, components, and/or groups thereof.

The present invention will now be described more fully herein after with reference to the accompanying drawings, in which preferred embodiments of the invention are shown. This invention may, however, be embodied in many different forms and should not be construed as limited by the embodiments set forth herein. Rather, these embodiments are provided so that this disclosure will be thorough and complete, and will fully convey the scope of the invention to those skilled in the art.

The present invention includes methods, systems, and computer program products for predicting reliability risks and/or yield of semiconductor products. Embodiments of the present invention may include a special purpose or general-purpose computer including various computer hardware or modules, as described in detail below.

As used herein, the term “module” or “unit” can refer to computer hardware, circuit, software objects or routines that perform a certain function or group of functions.

### Embodiment 1

In accordance with the present invention, a system of predicting a semiconductor device manufacturing process can prevent problems related to reliability and yield of a semiconductor device based on a predicted result obtained through inline acquisition of data associated with to-be predicted prediction information. The prediction of reliability risk and yield may be implemented using a neural network module. The expression “inline acquisition of data” refers to acquisition of data within a manufacturing process.

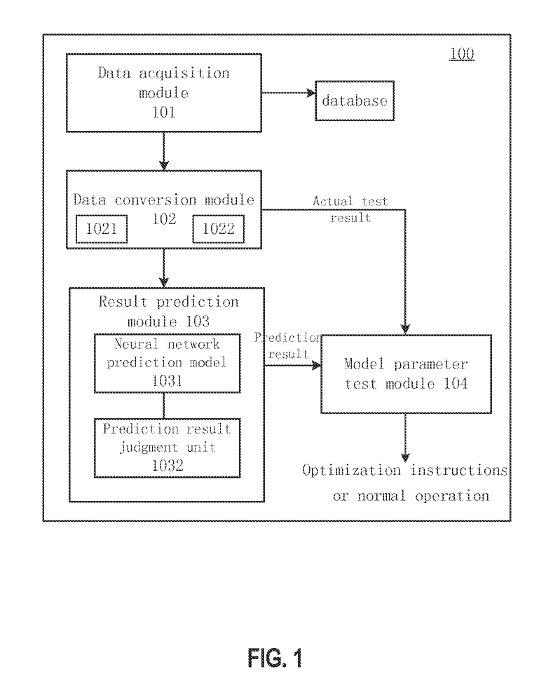

Referring to FIG. 1, a system 100 (alternatively also referred to as “the system” or “the prediction system” throughout the description) for predicting reliability and/or yield of a semiconductor device may include a data acquisition module 101, a data conversion module 102, and a result prediction module 103. Result prediction module 103 may include a neural network prediction module 1031 and a prediction result judgment unit 1032. System 100 may also include a model parameter test module 104.

In the embodiment, data acquisition module 101 is configured to acquire a variety of raw data (e.g., source data collected in a manufacturing process) associated with to-be predicted prediction information. The to-be predicted prediction information may include product reliability and yield and other information. The raw data may be acquired in real-time and stored in a database.

In an embodiment, data acquisition module 101 can automatically acquire data necessary to be analyzed and to be predicted (e.g., reliability or yield) that are associated with each manufacturing station or cell in a semiconductor device manufacturing processing line.

During the raw data acquisition, the raw data is screened in order to ensure that the acquired data is associated with the to-be predicted prediction information (e.g., reliability or yield). In the embodiment, the screening of the raw data associated with the to-be predicted prediction information may employ a regression analysis process. For example, data having a low correlation with an output result will be filtered out, i.e., the low-correlation data may not affect the output result. The prediction accuracy can be improved by using a regression analysis to screen the acquired raw data.

In an embodiment, after the screening, the acquired raw data may include:

A. Inline measurement data: referred to data associated with key process parameters that are measured and automatically transmitted to an appropriate statistical process control (SPC) system to generate statistics on measured data, and the measured data is screened and entered into a prediction model.

B. Machine monitoring system (iEMS) data: referred to real-time machine data as a manifestation of the machine in the real production process situation that is provided to the iEMS system through an input port of the iEMS system, and the data is then screened prior to inputting into the prediction model.

C: Waiting time (Q-time) data: referred to data related to the growth and defect of an oxide layer occurring during a process waiting time, the data may be obtained through calculation of product management information (WIP) of a manufacturing execution system (MES), and then automatically entered into the prediction model.

D: Wafer electrical test (WAT) data: referred to data of a wafer electrical test obtained through a WAT measurement station, the data is provided to a yield management system (YMS) and then screened again prior to inputting to the prediction model.

In the embodiment, a selection of the various data acquired by data acquisition module 101 (i.e., data inputted to the data acquisition module) may be made. The selection takes into account the impact that may have on the testing of the to-be predicted prediction information associated with the production process line.

For example, if a prediction model of reliability or yield of an inter-metal dielectric (IMD) layer needs to be established, then input factors (i.e., input data) may be selected with those important parameters associated with the inter-metal dielectric layer, e.g., parameters (power in the reaction chamber, pressure, the temperature of the thermal head, tetrafluoroethylene, silane gas, and the like) from the machine station (iEMS), measured data of inline silicon production process (e.g., thickness and width of the polished and etched metal layer) and waiting times between before and after process steps (that may affect the level of oxidation and other defective particles).

Real-time parameters of an in-process (inline) workcell may include:

Power, which may affect the rate of deposition and temperature of the silicon in production;

Pressure, which may affect the deposition rate and the film properties;

Heater head temperature, which may affect the deposition rate and density of the deposited film;

Gas and gas flow rate, which may affect the deposition rate and the film properties.

Inline measurement data may include the width of the metal wiring, the width of the trench, the thickness of the insulating layer, the diameter of the interconnect hole, etc. The line width of the metal wiring may affect the ability to fill the interconnect holes, e.g., a wide width of the metal wiring may cause voids in the film.

In the embodiment, data conversion module 102 is configured to convert the various raw data into normalized data in a format that can be processed by a computer.

In an exemplary embodiment, data conversion module 102 may include a data format conversion unit 1021 configured to perform data format conversion and a data normalization unit 1022 configured to perform data normalization. Data conversion module 102 converts various raw data into computable quantitative data and normalizes the converted raw data that is then provided to result prediction module 103 (mainly to neural network prediction model 1031) for further processing.

In the neural network prediction, normalized data using (0, 1) can get a more accurate prediction result. Thus, all data should be submitted to a pretreatment process (normalization) before the data can be provided to the prediction system.

In the present embodiment, data can be normalized using the following expression:

(Value−Min)/(Max−Min);

where Value is the actual data value, Max is the maximum data value and Min is the minimum value used for modeling the neural network prediction model.

In the present embodiment, result prediction module 103 computes the prediction result of the to-be predicted prediction information (e.g., reliability or yield) based on the converted data provided by data conversion module 102 (i.e., normalized data) and compares the prediction result with a predetermined prediction standard value.

Result prediction module 103 includes a neural network prediction model 1031 and a prediction judgment unit 1032. Neural network prediction model 1031 is configured to compute a prediction result of the to-be predicted prediction information based on the converted data provided by data conversion module 102. Prediction result judgment unit 1032 is configured to compare the prediction result of the to-be predicted prediction information with a predetermined prediction standard value that may include a valid standard value and an invalid standard value (e.g., a valid wiring standard value and an invalid wiring standard value). The comparison may produce one or more comparison results. Prediction result judgment unit 1032 then performs an appropriate judgment (decision) on the one or more comparison results.

In the embodiment, neural network prediction model 1031 is the core module of the system. For each batch of products, neural network prediction model 1031 computes the prediction result of the to-be predicted prediction information based on the converted data provided by data conversion module 102.

A neural network is a complex network system comprising a large number of simple processing units (called neurons) connected to each other to form a complex network system, which reflects the many basic features of the human brain function. A neural network is a highly complex nonlinear dynamic learning system. Neural networks have massively parallel and distributed storage and processing units having self-organization, adaptation and learning capability. Neural networks are particularly suitable for solving problems of processing factors and conditions that have imprecise and vague information. Neural network prediction model 1031 according to the embodiment of the present invention may compute a prediction result of the to-be predicted prediction information (e.g., reliability or yield) so that the prediction system may have the above-described advantages and benefits.

In the embodiment of the invention, neural network prediction model 1031, in addition to computing factors that determine the inputted data, also configures parameters of the neural network prediction model itself. Appropriate configuration parameters can be determined quickly using the design of experiments (DOE) approach.

In an embodiment, a process for determining configuration parameters by way of experimental designs (DOE) may include:

(1) setting a parameter experimental range including a range of percentages of training, validation, and test data and a range of neuron counts.

In general, a percentage of the sample size of any two of the training data, validation data and test data of a selected neural network may be used as parameters, the number of neurons may also need to be considered. For example, the percentage of the sample size of the selected validation data and test data, with the variation range being set to between about 10% and about 30%, the range of neuron counts can be determined according to the number of factors using the formula L=sqrt(m+n) as the range value plus 10 to 20 points, where m is the number of inputs, and n is the number of levels.

(2) conducting experiments through an experimental design table, which is designed using a Design of Experiment (DOE) technique.

It is recommended to use an optimal experiment design method that can minimize the number of experiments and improve accuracy.

(3) performing an average error judgment on the experimental results, and configuring neural network prediction model 1031 with the minimum average error parameter.

Typically, the neural network prediction model 1031 may be configured using the following steps:

Step A: Setting up the neural network prediction model. The optimal condition for training, validation, test data ratio and the number of hidden neurons can be generally found using a design of experiments (DOE) approach.

Step B: training and validating the neural network prediction model.

In general, an optimal condition of training and validation is used to set up the neural network prediction model. The maximum R-squared value and the minimum acceptance error count are used to decide the selection of the neural network prediction model.

In the embodiment, prediction result judgment unit 1032 is configured to compare the prediction result of the to-be predicted prediction information with a predetermined prediction standard value. The predetermined prediction standard value may include a valid standard value and an invalid standard value. Prediction result judgment unit 1032 may perform the following operations:

(i.) If the prediction result is above a valid standard value, the to-be predicted prediction information is determined to be normal and the manufactured products are ready to be shipped.

(ii.) If the prediction result is below the invalid standard value, the to-be predicted prediction information is determined to be abnormal. Responsible process engineers (such as reliability or yield improvement engineers) are automatically called in to measure and analyze the to-be predicted prediction information (e.g., reliability or yield).

(iii.) If the prediction result is within the valid standard value and the invalid standard value, it is determined that the product must go through further analysis. At this point the product may be sent to a responsible unit for further testing.

In the present embodiment, model parameter test module 104 is configured to compare, in a regular basis, the actual test result of the to-be predicted prediction information with the prediction result of the to-be predicted prediction information provided by result prediction module 103, and compare a false positive rate with a default standard rate. If the actual test result and/or the false positive rate exceed the respective prediction result and/or the default standard rate, then model parameter test module 104 causes an optimization process to be executed. If the actual test result or the false positive rate does not exceed the respective prediction result or the default standard rate, then the system may operate normally.

In an embodiment, model parameter test module 104 may be configured to:

(a) store, in a regular basis, the summary of test data of the to-be predicted prediction information (e.g., reliability or yield) of the products to a self-test model database.

(b) automatically determine, through the default standard rate, whether neural network prediction module 1031 is working properly, or whether or not there is a deviation of data.

(c) once model parameter test module 104 determines that the data deviation exceeds a predetermined maximum error value allowed, model parameter test module 104 will generate an alarm to alert an administrator to make a judgment on the parameters of neural network prediction model 1031. The alarm may be a false alarm and requires the judgment of the administrator.

Thus, in accordance with the present invention, the prediction system may include a data acquisition module 101, a data conversion module 102, and a result prediction module 103 that includes a neural network prediction model 1031. Neural network prediction model 1031 may compute the prediction result of the to-be predicted prediction information (such as reliability or yield) to prevent major reliability and/or yield problems from occurring during the manufacturing of a semiconductor device. Furthermore, because the prediction system computes the prediction result of reliability and/or yield through neural network prediction model 1031 in result prediction module 103, an optimal control of the reliability and/or yield can be achieved.

### Embodiment 2

Embodiments of the present invention provide a method for predicting product information in a semiconductor device manufacturing process that is performed using the above-described prediction system. The predicting method for product information in a semiconductor device manufacturing process may prevent major reliability and/or yield problems through inline data acquisition and the computed prediction result of the to-be predicted prediction information (reliability or yield). The prediction result of the to-be predicted prediction information (reliability or yield) is computed using a neural network prediction model.

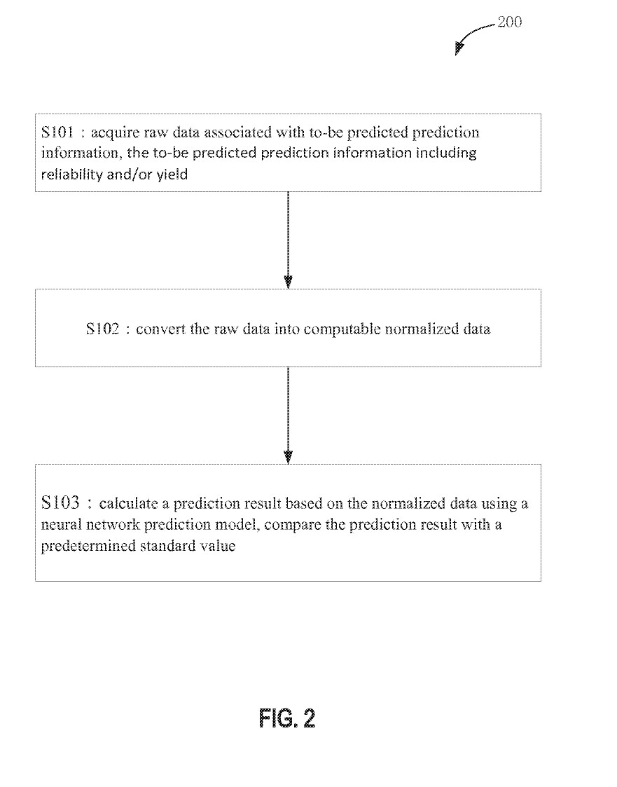

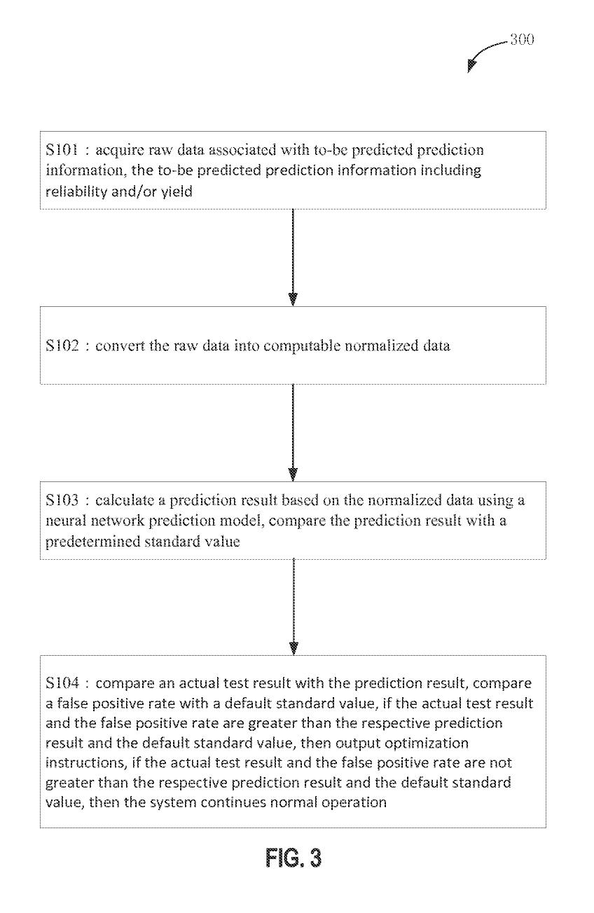

FIG. 2 is a simplified flow chart of a method 200 for predicting information of a semiconductor device according to one embodiment of the present invention. FIG. 3 is a simplified flow chart of a method 300 for predicting information of a semiconductor device according to another embodiment of the present invention

Referring to FIGS. 1 and 2, the method for predicting information of a semiconductor device may include:

Step S101: acquiring raw data that is associated with to-be predicted prediction information. The to-be predicted prediction information includes reliability and/or yield data of a semiconductor device.

The raw data can be acquired using data acquisition module 101 described in sections above.

In step S101, after the raw data has been acquired, the method further includes a step of screening and a step of storing the raw data into a specific database. Screening may be carried out using a regression analysis. For example, input data that have a low correlation to output responses are filtered out or eliminated.

In the embodiment, the raw data may include inline measurement data, machine (work cell, process station) monitoring system data, acceptable waiting time data, wafer test data, and the like. Machine monitoring system data may include power, pressure, temperature, and gas heater head. Inline measurement data may include a thickness of a metal layer after an etching process and/or a CMP process, a width of metal wirings and the like.

Step S102: converting the raw data into a normalized format (normalized data) that can be computed by a computer (a computable standard format). Step S102 can be implemented using data conversion module 102.

The conversion of raw data into computable normalized data includes a normalization step. Data can be normalized using the following expression:

(Value−Min)/(Max−Min);

where Value is the actual data value, Max is the maximum data value and Min is the minimum value used for modeling a neural network prediction model.

That is, the normalized data is the value obtained according to the expression (Value−Min)/(Max−Min).

Step S103: calculating the prediction result of the to-be predicted prediction information based on the normalized data using a neural network prediction model, and comparing the calculated prediction result with a predetermined standard value. Step 103 can be implemented using result prediction module 103. The neural network prediction model may be neural network prediction model 1031 described in above sections.

The neural network prediction model may include parameters that may be configured using the following process steps:

setting a parameter experimental range;

conducting experiments using an experimental design table to obtain one or more experimental results;

judging (determining) an average error of the experimental results, and setting the minimum average error as the configuration of the neural network prediction model.

In the embodiment, the comparison between the prediction result of the to-be predicted prediction information and the predetermined standard value can be implemented using prediction result judgment unit 1032 in above-described embodiment 1. The predetermined standard value may include multiple values, such as a valid standard value and an invalid standard value. The comparison between the prediction result of the to-be predicted prediction information and the predetermined standard value may include: comparing the prediction result of the to-be predicted prediction information with the predetermined standard value to obtain one or more comparison results, and making an appropriate judgment on the one or more comparison results. The appropriate judgment for the one or more comparison results may include:

In the event that the prediction results are above (i.e., greater than) the valid standard value, the prediction information is determined to be normal;

In the event that the prediction results are below (i.e., less than) the invalid standard value, the prediction information is determined to be abnormal;

In the event that the prediction results are between the invalid standard value and the valid standard value, the prediction information is determined to require further analysis.

The above process steps complete the description of the method of predicting a semiconductor device according the present invention.

Referring to FIG. 3, method 300 includes steps S101, S102, and S103 similar to the steps S101, S102, S103 of method 200. Method may further include, after step 103, step S104 to compare the prediction result with an actual result, and compare a false positive rate with a default standard rate. In the event that the actual result exceeds the prediction result and/or the false positive rate exceeds the default standard, then the prediction system may generate model optimization instructions. In the event that the actual result does not exceed the prediction result or the false positive rate does not exceed the default standard rate, then the prediction system operates normally.

Step 104 may be implemented by model parameter test module 104.

According to the present invention, the method for predicting a semiconductor device manufacturing process may include the following process steps: acquiring raw data associated with to-be predicted prediction information, converting the raw data into normalized data in a computable format that can be processed by a computer, and calculating a prediction result of the to-be predicted prediction information using a neural network prediction model. The prediction result can be calculated in real-time based on inline data using the neural network prediction model to prevent major reliability and/or yield problems.

FIG. 2 is a simplified flow chart of a method 200 for predicting a semiconductor device manufacturing process according to one embodiment of the present invention. Method 200 may include:

S101: acquiring raw data associated with to-be predicted prediction information; the to-be predicted prediction information may include reliability and/or yield of a semiconductor device.

S102: converting the acquired raw data into normalized data in a computable format;

S103: calculating a prediction result of the to-be predicted prediction information using a neural network prediction model, and comparing the calculated prediction result with a predetermined prediction standard value.

FIG. 3 is a simplified flow chart of a method 300 for predicting a semiconductor device manufacturing process according to one embodiment of the present invention. Method 300 may include:

S101: acquiring raw data associated with to-be predicted prediction information; the to-be predicted prediction information may include reliability and/or yield of a semiconductor device.

S102: converting the acquired raw data into a computer calculable normalized data;

S103: calculating a prediction result of the to-be predicted information using a neural network prediction model, and comparing the calculated prediction result with a predetermined prediction standard value;

S104: comparing an actual test result with the prediction result, and comparing a false positive rate with a default standard value. If the actual test result exceeds the prediction result and/or the false positive rate exceeds the default standard value, the prediction system may generate optimization instructions. If the actual test result does not exceed the prediction result and the false positive rate does not exceed the default standard value, the prediction system may operate normally.

While the present invention is described herein with reference to illustrative embodiments, this description is not intended to be construed in a limiting sense. Rather, the purpose of the illustrative embodiments is to make the spirit of the present invention be better understood by those skilled in the art. In order not to obscure the scope of the invention, many details of well-known processes and manufacturing techniques are omitted. Various modifications of the illustrative embodiments as well as other embodiments will be apparent to those of skill in the art upon reference to the description. It is therefore intended that the appended claims encompass any such modifications.

Furthermore, some of the features of the preferred embodiments of the present invention could be used to advantage without the corresponding use of other features. As such, the foregoing description should be considered as merely illustrative of the principles of the invention, and not in limitation thereof.

What is claimed is:

1. A system for product reliability and/or yield prediction, comprising:
a data acquisition module configured to acquire raw data associated with to-be predicted prediction information, the to-be predicted prediction information associated with product reliability and/or yield;
a data conversion module configured to convert the raw data into computable normalized data; and
a result prediction module configured to calculate a prediction result based on the normalized data and compare the prediction result with a predetermined standard value;
wherein the result prediction module comprises a neural network prediction model configured to calculate the prediction result based on the normalized data.

2. The system of claim 1, wherein the neural network prediction model comprises a plurality of parameters determined by:
an experimental range including a range of percentages of training, validation, and test data, and a range of neuron counts;
an experimental design table;
a minimum average error value and a maximum R-squared value.

3. The system of claim 1, wherein the result prediction module further comprises a prediction result judgment unit coupled to the neural network prediction model and configured to:
compare the prediction result with the predetermined standard value to obtain a comparison result; and
make an judgment in response to the comparison result.

4. The system of claim 3, wherein the predetermined standard value comprises a valid standard value and an invalid standard value and the prediction result judgment unit makes:
a normal operation judgment when the prediction result is above the valid standard value;
an abnormal operation judgment when the prediction result is below the invalid standard value;
an analysis judgment when the prediction result is between the invalid standard value and the valid standard value.

5. The system of claim 1, wherein the data acquisition module screens the acquired raw data and sends the screened data to a database for storage.

6. The system of claim 1, wherein the raw data comprises:
inline measurement data;
machine monitoring system data;
processing time and idle time data;
wafer electrical test data.

7. The system of claim 6, wherein the machine monitoring system data comprises power, pressure, thermal head temperature, gas, and the inline measurement data comprises a width of metal wirings, a width of trenches, a thickness of an insulating layer, a diameter of a through hole.

8. The system of claim 1, wherein the data conversion module comprises a data format conversion unit and a data normalization unit, the data normalization unit configured to perform the following expression:
(Value−Min)/(Max−Min)
where Value is an actual data value, and Max is a maximum data value and Min is a minimum value used for modeling the neural network prediction model.

9. The system of claim 1, further comprising a model parameter test module configured to:
compare an actual test result with the prediction result;
compare a false positive rate with a default value;
cause the system to output model optimization instructions in the event that the actual test result exceeds the prediction result and the false positive rate exceeds the default value; and
cause the system to operate normally in the event that the actual test result does not exceed the prediction result and the false positive rate does not exceed the default value.

10. A computer-implemented method for predicting product reliability and/or yield, the method comprising:
acquiring raw data associated with to-be predicted prediction information using a data acquisition module, the to-be predicted prediction information comprising the product reliability and/or yield;
converting the raw data into computable normalized data;
calculating a prediction result based on the normalized data using a neural network prediction model; and
comparing the prediction result with a predetermined standard value.

11. The computer-implemented method of claim 10, wherein the neural network prediction model comprises a plurality of parameters determined by the following steps:
setting an experimental range including a range of percentages of training, validation, and test data, and a range of neuron counts;
conducting experiments using an experimental design table to obtain one or more experimental results;
judging an average error value in response to the one or more experimental results;
determining a minimum error value as a parameter for the neural network prediction model.

12. The computer-implemented method of claim 10, wherein comparing the prediction result with the predetermined standard value comprises:
in the event that the prediction result is above a valid standard value, determining that the to-be predicted prediction information is normal;
in the event that the prediction result is below an invalid standard value, determining that the to-be predicted prediction information is abnormal;
in the event that the prediction result is between the valid standard value and the invalid standard value, determining that the to-be predicted prediction information is required to be submitted to an analysis.

13. The computer-implemented method of claim 10, wherein the raw data comprises:
inline measurement data;
machine monitoring system data;
processing time and idle time data;
wafer electrical test data.

14. The computer-implemented method of claim 10, wherein converting the raw data into computable normalized data comprises performing an operation using the following expression:
(Value−Min)/(Max−Min)
where Value is an actual data value, and Max is a maximum data value and Min is a minimum value used for modeling the neural network prediction model.

15. The computer-implemented method of claim 10, further comprising:
comparing an actual test result with the prediction result;
comparing a false positive rate with a default value;
in the event that the actual test result exceeds the prediction result and the false positive rate exceeds the default value, outputting instructions for model optimization;
in the event that the actual test result does not exceed the prediction result and the false positive rate does not exceed the default value, operating a manufacturing process normally.
